(19) United States
(12) Patent Application Publication
(10) Pub. No.: US 2024/0303860 A1
(43) Pub. Date: Sep. 12, 2024

(54) CROSS-VIEW VISUAL GEO-LOCALIZATION FOR ACCURATE GLOBAL ORIENTATION AND LOCATION

(71) Applicant: SRI International, Menlo Park, CA (US)

(72) Inventors: Niluthpol MITHUN, Dayton, NJ (US); Kshitij MINHAS, Lawrenceville, NJ (US); Han-Pang CHIU, West Windsor, NJ (US); Taragay OSKIPER, East Windsor, NJ (US); Mikhail SIZINTSEV, Highland Park, NJ (US); Supun SAMARASEKERA, Skillman, NJ (US); Rakesh KUMAR, West Windsor, NJ (US)

(21) Appl. No.: 18/600,424

(22) Filed: Mar. 8, 2024

Related U.S. Application Data
(60) Provisional application No. 63/451,036, filed on Mar. 9, 2023.

(51) Int. Cl. G06T 7/73

(52) U.S. Cl. CPC G06T 7/74; G06T 2207/20081; G06T 2207/20084

(57) ABSTRACT

A method, apparatus, and system for providing orientation and location estimates for a query ground image include determining spatial-aware features of a ground image and applying a model to the determined spatial-aware features to determine orientation and location estimates of the ground image. The model can be trained by collecting a set of ground images, determining spatial-aware features for the ground images, collecting a set of geo-referenced images, determining spatial-aware features for the geo-referenced images, determining a similarity of the spatial-aware features of the ground images and the geo-referenced images, pairing ground images and geo-referenced images based on the determined similarity, determining a loss function that jointly evaluates orientation and location information, creating a training set including the paired ground images and geo-referenced images and the loss function, and training the neural network to determine orientation and location estimates of ground images without the use of 3D data.

### CROSS-REFERENCE TO RELATED APPLICATIONS

This application claims benefit of and priority to U.S. Provisional Patent Application Ser. No. 63/451,036, filed Mar. 9, 2023

### GOVERNMENT RIGHTS

This invention was made with Government support under contract number N00014-19-C-2025 awarded by the Office of Naval Research. The Government has certain rights in this invention.

### FIELD OF THE INVENTION

Embodiments of the present principles generally relate to determining location and orientation information of objects and, more particularly, to a method, apparatus and system for determining accurate, global location and orientation information for, for example, objects in a ground image in outdoor environments.

### BACKGROUND

Estimating precise position (e.g., 3D) and orientation (e.g., 3D) of ground imagery and video streams in the world is crucial for many applications, including but not limited to outdoor augmented reality applications and real-time navigation systems, such as autonomous vehicles. For example, in augmented reality (AR) applications, the AR system is required to insert the synthetic objects or actors at the correct spots in an imaged real scene viewed by a user. Any drift or jitter on inserted objects, which can be caused by inaccurate estimation of camera poses, will disturb the illusion of mixture between rendered and real-world content for the user.

Geo-localization solutions for outdoor AR applications typically rely on magnetometer and GPS sensors. GPS sensors provide global 3D location information, while magnetometers measure global heading. Coupled with the gravity direction measured by an inertial measurement unit (IMU) sensor, the entire 6-DOF (degrees of freedom) geo-pose can be estimated. However, GPS accuracy degrades dramatically in urban street canyons and magnetometer readings are sensitive to external disturbance (e.g., nearby metal structures). There are also GPS-based alignment methods for heading estimation that require a system to be moved around at a significant distance (e.g., up to 50 meters) for initialization. In many cases, these solutions are not reliable for instantaneous AR augmentation.

Recently, there has been a lot of interest in developing techniques for geo-localization of ground imagery using different geo-referenced data sources. Most prior works consider the problem as matching queries against a pre-built database of geo-referenced ground images or video streams. However, collecting ground images over a large area is time-consuming and may not be feasible in many cases.

In addition, some approaches have been developed for registering a mobile camera in an indoor AR environment. Vision-based SLAM approaches perform quite well in such a situation. These methods can be augmented with pre-defined fiducial markers or IMU devices to provide metric measurements. However, they are only able to provide pose estimation in a local coordinate system, which is not suitable for outdoor AR applications.

To make such a system work in the outdoor setting, GPS and magnetometer can be used to provide a global location and heading measurements respectively. However, the accuracy of consumer-grade GPS systems, specifically in urban canyon environments, is not sufficient for many outdoor AR applications. Magnetometers also suffer from external disturbance in outdoor environments.

Recently, vision-based geo-localization solutions have become a good alternative for registering a mobile camera in the world, by matching the ground image to a pre-built geo-referenced 2D or 3D database. However, these systems completely rely on GPS and Magnetometer measurements for initial estimates, which, as described above, can be inaccurate and unreliable.

### SUMMARY

Embodiments of the present principles provide a method, apparatus and system for determining accurate, global location and orientation information of, for example, objects in ground images in outdoor environments.

In some embodiments, a computer-implemented method of training a neural network for providing orientation and location estimates for ground images includes collecting a set of ground images, determining spatial-aware features for each of the collected ground images, collecting a set of geo-referenced, downward-looking reference images, determining spatial-aware features for each of the collected geo-referenced, downward-looking reference images, determining a similarity of the spatial-aware features of the ground images with the spatial-aware features of the geo-referenced, downward-looking reference images, pairing ground images and geo-referenced, downward-looking reference images based on the determined similarity, determining a loss function that jointly evaluates both orientation and location information, creating a training set including the paired ground images and geo-referenced, downward-looking reference images and the loss function, and training, using the training set, the neural network to determine orientation and location estimates of ground images without the use of three-dimensional (3D) data.

In some embodiments, a method for providing orientation and location estimates for a query ground image includes receiving a query ground image, determining spatial-aware features of the received query ground image, and applying a model to the determined spatial-aware features of the received query ground image to determine the orientation and location of the query ground image. In some embodiments, the model can be trained by collecting a set of ground images, determining spatial-aware features for each of the collected ground images, collecting a set of geo-referenced, downward-looking reference images, determining spatial-aware features for each of the collected geo-referenced, downward-looking reference images, determining a similarity of the spatial-aware features of the ground images with the spatial-aware features of the geo-referenced, downward-looking reference images, pairing ground images and geo-referenced, downward-looking reference images based on the determined similarity, determining a loss function that jointly evaluates both orientation and location information, creating a training set including the paired ground images and geo-referenced, downward-looking reference images and the loss function, and training the neural network to determine orientation and location estimation of ground images using the training set.

In some embodiments, an apparatus for estimating an orientation and location of a query ground image includes a processor and a memory accessible to the processor, the memory having stored therein at least one of programs or instructions. In some embodiments, when the programs or instructions are executed by the processor, the apparatus is configured to determine spatial-aware features of a received query ground image, and apply a machine learning model to the determined features of the received query ground image to determine the orientation and location of the query ground image. In some embodiments, the model can be trained by collecting a set of ground images, determining spatial-aware features for each of the collected ground images, collecting a set of geo-referenced, downward-looking reference images, determining spatial-aware features for each of the collected geo-referenced, downward-looking reference images, determining a similarity of the spatial-aware features of the ground images with the spatial-aware features of the geo-referenced, downward-looking reference images, pairing ground images and geo-referenced, downward-looking reference images based on the determined similarity, determining a loss function that jointly evaluates both orientation and location information, creating a training set including the paired ground images and geo-referenced, downward-looking reference images and the loss function, and training, using the training set, the neural network to determine orientation and location estimates of ground images without the use of three-dimensional (3D) data.

A system for providing orientation and location estimates for a query ground image includes a neural network module including a model trained for providing orientation and location estimates for ground images, a cross-view geo-registration module configured to process determined spatial-aware image features, an image capture device, a database configured to store geo-referenced, downward-looking reference images, and an apparatus including a processor and a memory accessible to the processor, the memory having stored therein at least one of programs or instructions. In some embodiments, when the programs or instructions are executed by the processor, the apparatus is configured to determine spatial-aware features of a received query ground image, captured by the capture device, using the neural network module, and apply the model to the determined spatial-aware features of the received query ground image to determine the orientation and location of the query ground image. In some embodiments, the model can be trained by collecting a set of ground images, determining spatial-aware features for each of the collected ground images, collecting a set of geo-referenced, downward-looking reference images, determining spatial-aware features for each of the collected geo-referenced, downward-looking reference images, determining a similarity of the spatial-aware features of the ground images with the spatial-aware features of the geo-referenced, downward-looking reference images, pairing ground images and geo-referenced, downward-looking reference images based on the determined similarity, determining a loss function that jointly evaluates both orientation and location information, creating a training set including the paired ground images and geo-referenced, downward-looking reference images and the loss function, and training, using the training set, the neural network to determine orientation and location estimates of ground images without the use of three-dimensional (3D) data.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a cross-view visual geo-localization system in accordance with an embodiment of the present principles.

FIG. 2 depicts a graphical representation of the functionality of a cross-view visual geo-localization system of the present principles, such as the cross-view visual geo-localization system of FIG. 1 in accordance with an embodiment of the present principles.

FIG. 3 depicts a high-level block diagram of a neural network that can be implemented, for example, in a neural network feature extraction module of the cross-view visual geo-localization system of FIG. 1 in accordance with an embodiment of the present principles.

FIG. 4 depicts an algorithm for global orientation estimation in accordance with an embodiment of the present principles.

FIG. 5 depicts a first Table including location estimation results of a cross-view visual geo-localization system of the present principles on a CVUSA dataset and a second Table including location estimation results of the cross-view visual geo-localization system on a CVACT dataset in accordance with an embodiment of the present principles.

FIG. 6 depicts a third Table including orientation estimation results of a cross-view visual geo-localization system of the present principles on the CVUSA dataset and a fourth Table including orientation estimation results of the cross-view visual geo-localization system, on the CVACT dataset in accordance with an embodiment of the present principles.

FIG. 7, depicts a fifth Table including results of the application of a cross-view visual geo-localization system of the present principles to image data from experimental navigation sequences in accordance with an embodiment of the present principles.

FIG. 8 illustratively depicts three screenshots of a semi-urban scene of a first set of experimental navigation sequences in which augmented reality objects have been inserted in accordance with an embodiment of the present principles.

FIG. 9 depicts a flow diagram of a computer-implemented method of training a neural network for orientation and location estimation of ground images in accordance with an embodiment of the present principles.

FIG. 10 depicts a flow diagram of a method for estimating an orientation and location of a ground image (query) in accordance with an embodiment of the present principles.

FIG. 11 depicts a high-level block diagram of a computing device suitable for use with a cross-view visual geo-localization system in accordance with embodiments of the present principles.

FIG. 12 depicts a high-level block diagram of a network in which embodiments of a cross-view visual geo-localization system in accordance with the present principles can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for determining accurate, global location and orientation information of, for example, objects in ground images in outdoor environments. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles are described as providing orientation and location estimates of images/videos captured by a camera on the ground for the purposes of inserting augmented reality images at accurate locations in a ground-captured image/video, in alternate embodiments of the present principles, orientation and location estimates of ground-captured images/videos provided by embodiments of the present principles can be used for substantially any applications requiring accurate orientation and location estimates of ground-captured images/videos, such as real-time navigation systems.

The phrases ground image(s), ground-captured image(s), and camera image(s), and any combination thereof, are used interchangeably in the teachings herein to identify images/videos captured by, for example, a camera on or near the ground. In addition, the description of determining orientation and location information for a ground image and/or a ground query image is intended to describe the determination of orientation and location information of at least a portion of a ground image and/or a ground query image including at least one object of a portion of a subject ground image.

The phases reference image(s), satellite image(s), aerial image(s), geo-referenced image(s) and any combination thereof, are used interchangeably in the teachings herein to identify geo-referenced images/videos captured by, for example, a satellite and/or an aerial capture device above the ground and generally to define downward-looking reference images.

Embodiments of the present principles provide a new vision-based cross-view geolocalization solution that matches camera images to geo-referenced satellite/aerial data sources, for, for example, outdoor AR applications and outdoor real-time navigation systems. Embodiments of the present principles can be implemented to augment existing magnetometer and GPS-based geo-localization methods. In some embodiments of the present principles, camera images (e.g., in some embodiments two-dimensional (2D) camera images) are matched to satellite reference images (e.g., in some embodiments 2D satellite reference images) from, for example, a database, which are widely available and easier to obtain than other 2D or 3D geo-referenced data sources. Because features of images determined in accordance with the present principles include spatial-aware features, embodiments of the present principles can be implemented to determine orientation and location information/estimates for, for example ground images, without the need for 3D image information from ground and/or reference images.

That is, previous to embodiments of the present principles described herein, in the context of ground image geo-registration, the use of 3D information in ground image geo-registration was required to ensure accuracy and spatial fidelity. This is, previously 3D information of 3D captured images was necessary for understanding spatial relationships between objects in the scene, which is helpful for correctly aligning ground images within a geographical context.

For example, there were several approaches to geo-registration (i.e., determining location and orientation) of ground images that involved matching ground images with geo-referenced 3D point cloud data, including (1) Direct Matching to 3D Point Clouds Using Local Feature-Based Registration, which involves extracting distinctive features like keypoints or descriptors (e.g., SIFT, SuperPoint) from both the ground images and the 3D point cloud to establish relationships between the image and the 3D data; and (2) Matching to 2D Projections of Point Cloud Data at a Grid of Locations, which includes, instead of directly using the 3D point cloud, projecting the point cloud data onto a uniform grid of possible locations on the ground plane. By aligning regions in the image and 3D data that share similar semantic content, these techniques achieved robust registration results, especially in scenes with complex structures.

However, acquiring high-fidelity 3D geo-referenced data is very expensive, primarily due to the costs associated with capture devices, such as LiDAR and photogrammetry technologies. In addition, in the context of publicly available data, such 3D data is scarce and can be often limited in coverage, particularly in remote areas. In addition, commercial sources often impose licensing limitations. When 3D data is available, most cases the data are of low fidelity, require large storage, and have gaps in coverage. Also, integrating data from different sources can be challenging due to differences in formats, coordinate systems, fidelity.

In contrast, embodiments of the present principles focus on matching 2D camera images to a 2D satellite reference image from, for example, a database, which is widely publicly available across the world and easier to be obtained than 3D geo-referenced data sources. Because features of ground images and satellite/reference images are determined as spatial-aware images in accordance with the present principles and as described herein, orientation estimates and location estimates can be provided for ground images without the use of 3D data.

Embodiments of the present principles provide a system to continuously estimate 6-DOF camera geo-poses for providing accurate orientation and location estimates for ground-captured images/videos, for, for example, outdoor augmented reality applications and outdoor real-time navigation systems. In such embodiments, a tightly coupled visual-inertial-odometry module can provide pose updates every few milliseconds. For example, in some embodiments, for visual-inertial navigation, a tightly coupled error-state Extended Kalman Filter (EKF) based sensor fusion architecture can be utilized. In addition to the relative measurements from frame-to-frame feature tracks for odometry purposes, in some embodiments, the error-state EKF framework is capable of fusing global measurements from GPS and refined estimates from the Geo-Registration module, for heading and location correction to counter visual odometry drift accumulation over time. To correct for any drift, embodiments of the present principles can estimate 3-DOF (latitude, longitude and heading) camera pose, by matching ground camera images to aerial satellite images. The visual geolocalization of the present principles can be implemented for providing both, initial global heading and location (cold-start procedure) and also continuous global heading refinement over time.

Embodiments of the present principles propose a novel transformer neural network-based framework for cross-view visual geo-localization solution. Compared to previous neural network models for cross-view geo-localization, embodiments of the present principles address several key limitations. First, because joint location and orientation estimation requires a spatially-aware feature representation, embodiments of the present principles include a step change in the model architecture. Second, embodiments of the present principles modify commonly used triplet ranking loss functions to provide explicit orientation guidance. The new loss function of the present principles leads to a highly accurate orientation estimation and also helps to jointly improve location estimation accuracy. Third, embodiments of the principles present a new approach that supports any camera movement (no panorama requirements) and utilizes temporal information for providing accurate and stable orientation of location estimates of ground images for, for example, enabling stable and smooth AR augmentation and outdoor, real-time navigation.

Embodiments of the present principles provide a novel Transformer based framework for crossview geo-localization of ground query images, by matching ground images to geo-referenced aerial satellite images, which includes a weighted triplet loss to train a model, that provides explicit orientation guidance for location retrieval. Such embodiments provide high granularity orientation estimation and improved location estimation performance, which extend image-based geo-localization by utilizing temporal information across video frames for continuous and consistent geo-localization, which fits the demanding requirements in real-time outdoor AR applications.

In general, embodiments of the present principles train a model using location-coupled pairs of ground images and aerial satellite images to provide accurate and stable location and orientation estimates for ground images. In some embodiments of the present principles a two-branch neural network architecture is provided to train a model using location-coupled pairs of ground images and aerial satellite images. In such embodiments, one of the branches focuses on encoding ground images and the other branch focuses on encoding aerial reference images. In some embodiments, both branches consist of a Transformer-based encoder-decoder backbone as described in greater detail below.

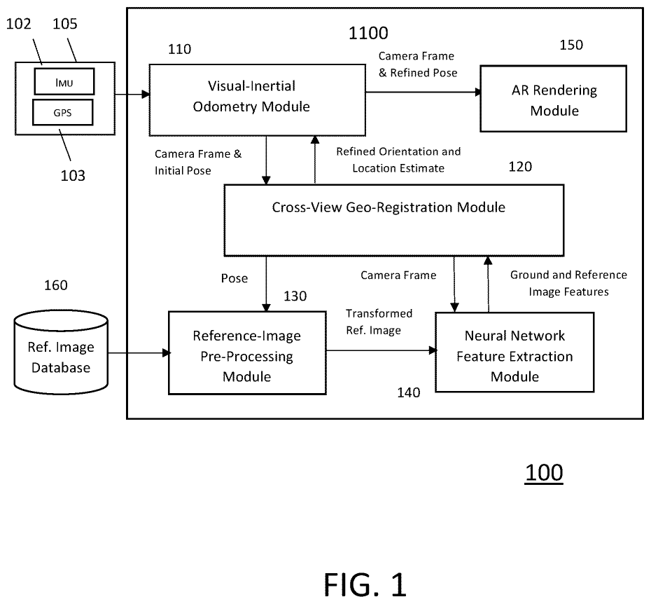

FIG. 1 depicts a high-level block diagram of a cross-view visual geo-localization system 100 in accordance with an embodiment of the present principles. The geo-localization system 100 of FIG. 1 illustratively includes a visual-inertial-odometry module 110, a cross-view geo-registration module 120, a reference image pre-processing module 130, and a neural network feature extraction module 140. In the embodiment of FIG. 1, the cross-view visual geo-localization system 100 of FIG. 1 further illustratively comprises an optional augmented reality (AR) rendering module 150 and an optional storage device/database 160. Although in the embodiment of FIG. 1 the cross-view visual geo-localization system 100 comprises an optional AR rendering module 150, in some embodiments, a cross-view geo-localization module of the present principles can output accurate location and orientation information to other systems such as real-time navigation systems and the like, including autonomous driving systems.

As depicted in FIG. 1, embodiments of a cross-view visual geo-localization system of the present principles, such as the cross-view visual geo-localization system 100, can be implemented via a computing device 1100 (described in greater detail below) in accordance with the present principles.

In the embodiment of the cross-view visual geo-localization system 100 of FIG. 1, ground images/video stream captured using a sensor package that can include a hardware synchronized inertial measurement unit (IMU) 102, a set of cameras 105, which can include a stereo pair of cameras and an RGB color camera, and a GPS device 103, can be communicated to the visual-inertial-odometry module 110. That is, In the cross-view visual geo-localization system 100 of FIG. 1, raw sensor readings from both the IMU 102 and the stereo cameras of the set of cameras 105 can be communicated to the visual-inertial-odometry module 110. The RGB color camera of the set of cameras 105 can be used for AR augmentation (described in greater detail below).

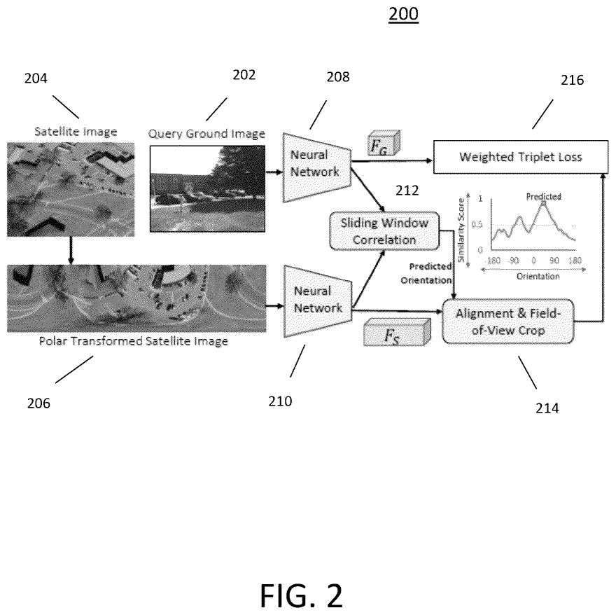

FIG. 2 depicts a graphical representation 200 of the functionality of a cross-view visual geo-localization system of the present principles, such as the cross-view visual geo-localization system 100 of FIG. 1, in accordance with at least one embodiment of the present principles. Embodiments of the present principles, explicitly consider orientation alignment in a loss function to improve joint location and orientation estimation performance. For example, in the embodiment of FIG. 2, a two-branch neural network architecture is implemented to help train a model using location-coupled pairs of a ground image 202 and an aerial satellite image 204, which considers orientation alignment in the loss function. In the embodiment of FIG. 2, the satellite image 204 is pre-processed, illustratively, by implementing a polar transformation 206 (described in greater detail below). A first branch of the two-branch architecture focuses on encoding the ground image 202 and a second branch focuses on encoding the pre-processed, aerial reference image 204. In the embodiment of FIG. 2, the branches respectively consist of a first neural network 208 and a second neural network 210, each including a Transformer-based encoder-decoder backbone to determine respective, spatial-aware features, [symbol] _{G}, [symbol] _{S}, of ground images and aerial reference images.

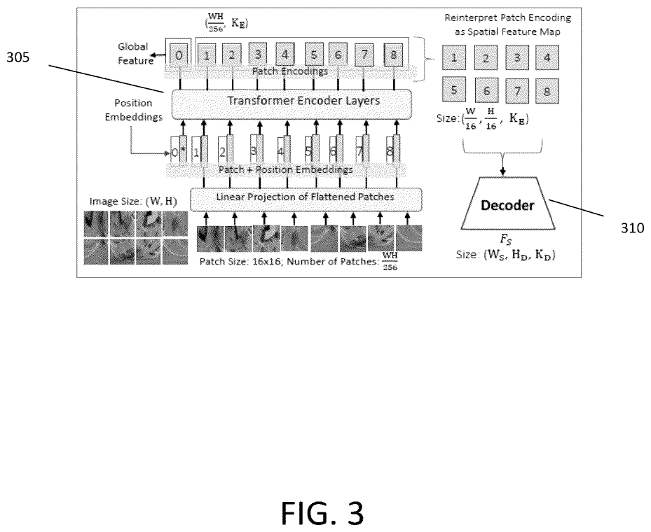

For example, FIG. 3 depicts a high-level block diagram of a neural network 208, 210 of FIG. 2 that can be implemented, for example, in a neural network feature extraction module of the present principles, such as the neural network feature extraction module 140 of FIG. 1, for extracting spatial-aware image features, [symbol] _{G}, [symbol] _{S}, of ground images and aerial reference images. The neural network of the embodiment of FIG. 3 illustratively comprises a vision transformer (ViT). The VIT of FIG. 3 splits an image into a sequence of fixed-size (e.g. 16×16) patches. The patches are flattened and the features are embedded. That is, the Transformer encoder of the VIT of the neural network of FIG. 3 uses constant vector/embedding, for example sized D, through all of its layers. In such embodiments, the patches are flattened and mapped to, for example, D dimensions with a trainable linear projection layer. The training of the neural network of the present principles is described in greater detail below.

In some embodiments, an extra classification token (CLS) can be added to the sequence of embedded tokens. Position embeddings can be added to the tokens to preserve position information, which is crucial for vision applications. The resulting sequence of tokens can be passed through stacked transformer encoder layers. For example, the Transformer encoder contains a sequence of blocks consisting of a multi-headed, self-attention modules and a feed-forward network. The feature encoding corresponding to the CLS token is considered as a global feature representation, which can be considered as a pure location estimation problem. To address the problem, an up-sampling decoder 310 following the transformer encoder 305 can be implemented. The decoder 310 alternates convolutional layers and bilinear upsampling operations. Based on the patch features from the transformer encoder 305, the decoder 310 is used to obtain the target spatial feature resolution. The encoder-decoder model of the VIT of FIG. 3 can generate a spatial-aware representation by, first, reshaping the sequence of patch encoding from a 2D shape of size

$$\frac{WH}{256} \times {K}_{E}$$

to a 3D feature map of size

$$\frac{W}{16} \times \frac{H}{16} \times {K}_{E} .$$

The decoder of the VIT 115 then takes this 3D feature map as input and outputs a final spatial-aware feature representation F. Because features of images determined by the neural networks in accordance with the present principles include spatial-aware features, embodiments of the present principles can be implemented to determine orientation and location information using only 2D images without the need for 3D image information to determine orientation and location information for, for example, ground images.

Referring back to the embodiment of FIG. 2, an orientation can be predicted using the spatial-aware feature representations from the first neural network 208 and the second neural network 210. That is, in accordance with the present principles, in some embodiments the spatial-aware feature representations of a ground image(s) from the first neural network 208 can be compared to and aligned with the spatial-aware features of reference/aerial image(s) from the second neural network 210 to determine an orientation for a subsequent query, ground image (described in greater detail below). As depicted in FIG. 2, in some embodiments a sliding window correlation process 212 can be used for determining the orientation of a query ground image (described in greater detail below). In accordance with the present principles, the orientation predicted using the sliding window correlation process 212 can be considered in a weighted triplet loss process 216 to enforce a model to learn precise orientation alignment and location estimation jointly (described in greater detail below). As depicted in the embodiment of FIG. 2, in some embodiments of the present principles a predicted orientation can be further aligned and cropped using an alignment and field-of-view crop process 214 (described in greater detail below).

Referring back to the cross-view visual geo-localization system 100 of FIG. 1, the visual-inertial-odometry module 110 receives raw sensor readings from at least one of the IMU 102, the GPS device 103 and the set of cameras 105. The visual-inertial-odometry module 110 determines pose information and camera frame information of the received ground images and can provide updates every few milliseconds. That is, the visual-inertial odometry can provide robust estimates for tilt and in-plane rotation (roll and pitch) due to gravity sensing. Therefore, any drift in determined pose estimations occurs mainly in the heading (yaw) and position estimates. In accordance with the present principles, any drift can be corrected by matching ground camera images to aerial satellite images as described herein.

In the embodiment of the cross-view visual geo-localization system 100 of FIG. 1, the pose information of the ground images determined by the visual-inertial-odometry module 110 is illustratively communicated to the reference image pre-processing module 130 and the camera frame information determined by the visual-inertial-odometry module 110 is illustratively communicated to the neural network feature extraction module 140 through the cross-view geo-registration module 120 for ease of illustration. Alternatively or in addition, in some embodiments of the present principles the pose information of the ground images determined by the visual-inertial-odometry module 110 can be directly communicated to the reference image pre-processing module 130 and the camera frame information determined by the visual-inertial-odometry module 110 can be directly communicated to the neural network feature extraction module 140.

In the embodiment of the cross-view visual geo-localization system 100 of FIG. 1, reference satellite/aerial images can be received at the reference image pre-processing module 130 from, for example, the optional database 160. Alternatively or in addition, in some embodiments reference satellite/aerial images can be received from sources other than the optional database 160, such as via user input and the like. Due to drastic viewpoint changes between cross-view ground and aerial images, embodiments of a reference image pre-processing module of the present principles, such as the reference image pre-processing module 130 of FIG. 1, can apply a polar transformation (previously mentioned with respect to FIG. 2) to received satellite images, which focuses on projecting satellite image pixels to the ground-level coordinate system. In some embodiments, polar transformed satellite images are coarsely geometrically aligned with ground images and used as a pre-processing step to reduce the cross-view spatial layout gap. The width of the polar transformed image can be constrained to be proportional to the field of view in the same measure as the ground images. As such, when the ground image has a field of view (FoV) of 360 degrees (e.g., panorama), the width of the ground image should be the same size as the polar transformed image. Additionally, in some embodiments the polar transformed image can be constrained to have the same vertical size (e.g., height) as the ground images.

In the embodiment of the cross-view visual geo-localization system 100 of FIG. 1, the pre-processed reference satellite/aerial images from the reference image pre-processing module 130 can be communicated to the neural network feature extraction module 140. At the neural network feature extraction module 140, features can be determined for the pre-processed reference satellite/aerial images from the reference image pre-processing module 130 and the camera frame information from the visual-inertial-odometry module 110. For example, in some embodiments, and as described above with reference to FIG. 2, the neural network feature extraction module 140 can include a two-branch neural network architecture to determine respective features, [symbol] _{G}, [symbol] _{S}, of ground images and aerial reference images using the received information described above. In such embodiments, functionally, one of the branches of the two-branch architecture focuses on encoding ground images and the other branch focuses on encoding pre-processed, aerial reference images. Alternatively or in addition, in some embodiments the neural network feature extraction module 140 can include one or more branches including, for example, one or more ViT devices to determine features of ground images and aerial reference images as described above with reference to FIG. 2.

As further described above and with reference to FIG. 2 and FIG. 3, a neural network architecture of the present principles can be implemented to help train a model using location-coupled pairs of a ground image(s) 202 and aerial satellite image(s) 204. More specifically, in some embodiments of the present principles, the neural network feature extraction module 140 of the cross-view visual geo-localization system 100 of FIG. 1 can train a model to identify reference satellite images that correspond to/match query ground images in accordance with the present principles. That is, in some embodiments, a neural network feature extraction module of the present principles, such as the neural network feature extraction module 140 of the cross-view visual geo-localization system 100 of FIG. 1, can train a learning model/algorithm using a plurality of ground images from, for example, benchmark datasets (e.g., CVUSA and CVACT datasets), and reference satellite images to train a learning model/algorithm of the present principles to identify ground-satellite image pairs, (I_{G}, I_{S}) based on, for example, a similarity of the spatial features of the ground images and the reference satellite images, ( [symbol] _{G}, [symbol] _{S}), in accordance with the present principles.

In some embodiments, a model/algorithm of the present principles can include a multi-layer neural network comprising nodes that are trained to have specific weights and biases. In some embodiments, the learning model/algorithm can employ artificial intelligence techniques or machine learning techniques to analyze received data images including wafer defects on at least a portion of a processed wafer. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data.

For example, in some embodiments, a model of the present principles can include an embedding space that is trained to identify ground-satellite image pairs, (I_{G}, I_{S}) based on, for example, a similarity of the spatial features of the ground images and the reference satellite images, ( [symbol] _{G}, [symbol] _{S}). In such embodiments, spatial feature representations of the features of a ground image and the matching/paired satellite image can be embedded in the embedding space.

In some embodiments, to enforce the model to learn precise orientation alignment and location estimation jointly, an orientation-weighted triplet ranking loss can be implemented according to equation two (2), which follows:

$${ℒ}_{T} = {W}_{Ori} * {ℒ}_{GS} . \qquad ( 2 )$$

In equation two (2), [symbol] _{GS} depicts a soft margin triplet ranking loss that attempts to bring feature embeddings of matching pairs closer while pushing the feature embeddings of not matching pairs further apart. In some embodiments, [symbol] _{GS} can be defined according to equation three (3), which follows:

$${ℒ}_{GS} = log ( 1 + {e}^{α ( {‖ {𝔽}_{G} - {𝔽}_{S} ‖}_{F} - {‖ {𝔽}_{G} - {𝔽}_{\hat{S}} ‖}_{F} )} ) , \qquad ( 3 )$$

where [symbol] _{Ŝ} represents a non-matching satellite image feature embedding for ground image feature embedding [symbol] _{G}, and [symbol] _{S} represents the matching (i.e., location paired) satellite image feature embedding. In equation three (3), ∥·∥_{F} denotes the Frobenius and the parameter, α, is used to adjust the convergence speed of training. The loss term of equation three (3) attempts to ensure that for each query ground image feature, the distance with the matching crossview satellite image feature is smaller than the distance with the non-matching satellite image features.

As described above, in some embodiments, the triplet ranking loss function can be weighted based on the orientation alignment accuracy with the weighting factor, c. The weighting factor is implemented to attempt to provide explicit guidance based on orientation alignment similarity scores (i.e., with respect to Equation one (1)), which can be defined according to equation four (4), which follows:

$${W}_{Ori} = 1 + β * \frac{{𝕊}_{max} - {𝕊}_{GT}}{{𝕊}_{max} - {𝕊}_{Min}} , \qquad ( 4 )$$

where β represents a scaling factor. [symbol] ₘₐₓ and [symbol] _{Min} are, respectively, the maximum and minimum value of similarity scores. [symbol] _{GT} is the similarity score at the ground-truth position. The weighting factor, W_{Ori}, attempts to apply a penalty on the loss when [symbol] ₘₐₓ and [symbol] _{GT} are not the same.

For a single camera frame, as described above, the highest similarity score along the horizontal direction matching the satellite reference usually serves as a good orientation estimate. However, a single frame might have quite limited context especially when the camera FoV is small. As such, there is a possibility of significant ambiguity in some cases and a location and/or orientation estimate provided by embodiments of the present principles is unlikely to be reliable/stable for, for example, outdoor AR. However, embodiments of the present principes have access to frames continuously and, in some embodiments, can jointly consider multiple sequential frames to provide a high-confidence and stable location and/or orientation estimate in accordance with the present principles. That is, the single image-based cross-view matching approach of the present principles can be extended to using a continuous stream of images and relative poses between the images. For example, in some embodiments in which the visual-inertial-odometry module 110 is equipped with a GPS, only orientation estimation needs to be performed.

In the embodiment of the cross-view visual geo-localization system 100 of FIG. 1, the reference/satellite image features determined from the pre-processed reference/satellite images and the camera/ground image features determined from the camera frame information and the model determined by the neural network feature extraction module 140 can be communicated to the cross-view geo-registration module 120.

Subsequently, when a query ground image is received by the visual-inertial odometry module 110 of the cross-view visual geo-localization system 100 of FIG. 1, information regarding the query ground image, such as camera frame and initial pose information, can be communicated to the neural network 140. The spatial features of the query ground image can be determined at the neural network 140 as described above in FIG. 2 and FIG. 3 and in accordance with the present principles.

The determined features of the query ground image can be communicated to the cross-view geo-registration module 120. The cross-view geo-registration module 120 can then apply the previously determined model to determine location and orientation information for the query ground image. For example, in some embodiments, the determined features of the query ground image can be projected into the model embedding space to identify at least one of a reference satellite image and/or a paired ground image of an embedded ground-satellite image pair, (I_{G}, I_{S}), that can be paired with (e.g., has features most similar to) the query ground image based on at least the determined features of the query ground image. Subsequently, a location for the query ground image can be determined using the location of at least one of the embedded ground-satellite image pairs, (I_{G}, I_{S}) most similar (e.g., in location in the embedding space and/or similar in features) to the projected query ground image.

In some embodiments of the present principles, an orientation for the query ground image can be determined by comparing and aligning the determined features of the query ground image with the spatial-aware features of reference/aerial image(s) determined by, for example, a neural network 140 of the present principles to determine an orientation for the query ground image. For example, in some embodiments of the cross-view visual geo-localization system 100 of FIG. 1, the cross-view geo-registration module 120 provides orientation alignment between features of a ground query image and features of an aerial reference/image using, for example, sliding window matching techniques to estimate orientation alignment. In accordance with the present principles, the orientation alignment between cross-view images can be estimated based on the assumption that the feature representation of the ground image and polar transformed aerial reference image should be very similar when they are aligned. As such, in some embodiments, the cross-view geo-registration module 120 can apply a search window (i.e., of the size of the ground feature) that can be slid along the horizontal direction (i.e., orientation axis) of the feature representation obtained from the aerial image, and the similarity of the ground feature can be computed with the satellite/aerial reference features at all the possible orientations. The horizontal position corresponding to the highest similarity can then be considered to be the orientation estimate of the ground query with respect to the polar-transformed satellite/aerial one. For example, in an embodiment including a ground-satellite image pair, (I_{G}, I_{S}), the spatial feature representation is denoted as ( [symbol] _{G}, [symbol] _{S}). In this representation [symbol] _{S}∈R^{W}^{_{S}}^{×H}^{_{D}}^{×K}^{_{D}} and [symbol] _{G}∈R^{W}^{_{G}}^{×H}^{_{D}}^{×K}^{_{D}}. In instances in which the ground image is a panorama, W_{G} is the same as W_{S}; otherwise, W_{G} is smaller than W_{S}. The similarity, [symbol] , between [symbol] _{G} and [symbol] _{S} at the horizontal position, i, can be determined according to equation one (1) below, which follows:

$$S ( i ) = {\sum }_{k = 1}^{{K}_{D}} {\sum }_{h = 1}^{{H}_{D}} {\sum }_{w = 1}^{{W}_{G}} {𝔽}_{G} [ w , h , k ] {𝔽}_{S} [ ( w + i ) \% {W}_{s} , h , k ] , \qquad ( 1 )$$

where % denotes the modulo operator. In equation one (1) above, [symbol] [w, h, k] denotes the feature activation at index (w, h, k) and i={1, . . . . W_{S}}. The granularity of the orientation prediction depends on the size of W_{S}, as there are W_{S} possible orientation estimates and hence, orientation prediction is possible for every

$$\frac{360}{{W}_{s}}$$

degree. Hence, a larger size of W_{S} would enable orientation estimation at a finer scale. From the calculated similarity vector, [symbol] , the position of the maximum value of S is the estimated orientation of the ground query. As such, when [symbol] ₘₐₓ denotes the maximum value of similarity scores and [symbol] _{GT} denotes the value of the similarity score at the ground-truth orientation, when [symbol] ₘₐₓ and [symbol] _{GT} are the same, there exists perfect orientation alignment between the query ground and reference images.

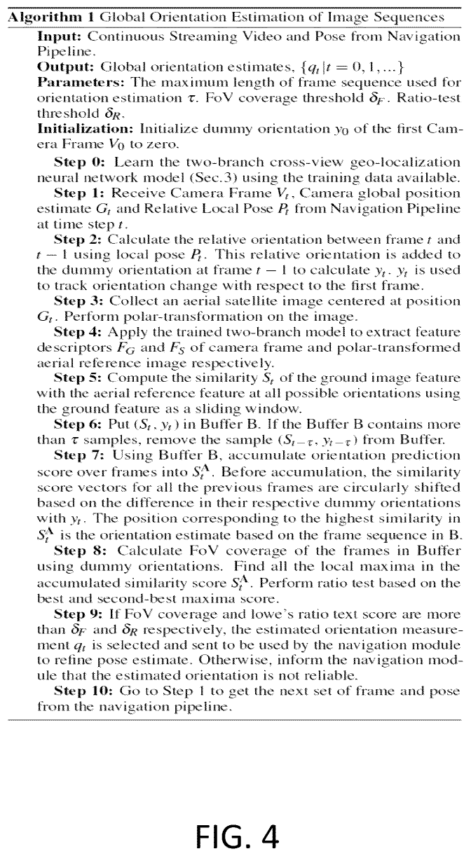

FIG. 4 depicts an algorithm/model of the present principles for global orientation estimation for, for example, continuous frames in accordance with an embodiment of the present principles. The algorithm of the embodiment of FIG. 4 begins with comments indicating as follows:

Input: Continuous Streaming Video and Pose from Navigation Pipeline.

Output: Global orientation estimates, {qt|t=0, 1, . . . }.

Parameters: The maximum length of frame sequence used for orientation estimation τ. FoV coverage threshold δF. Ratio-test threshold δR.

Initialization: Initialize dummy orientation y₀ of the first Camera Frame V₀ to zero.

The algorithm of FIG. 4 begins at Step 0: Learn the two-branch cross-view geo-localization neural network model using the training data available. At Step 1: Receive Camera Frame Vₜ, Camera global position estimate Gₜ and Relative Local Pose Pₜ from Navigation Pipeline at time step t. At Step 2: Calculate the relative orientation between frame t and t−1 using local pose Pₜ. This relative orientation is added to the dummy orientation at frame t−1 to calculate yₜ. yₜ is used to track orientation change with respect to the first frame. At Step 3: Collect an aerial satellite image centered at position Gₜ. Perform polar-transformation on the image. At Step 4: Apply the trained two-branch model to extract feature descriptors F_{G} and F_{SG} of camera frame and polar-transformed aerial reference image respectively. At Step 5: Compute the similarity Sₜ of the ground image feature with the aerial reference feature at all possible orientations using the ground feature as a sliding window. At Step 6: Put (Sₜ, yₜ) in Buffer B. If the Buffer B contains more than t samples, remove the sample (S_{t-τ}, y_{t-τ}) from Buffer. At step 7: Using Buffer B, accumulate orientation prediction score over frames into Sₜ^{A}. Before accumulation, the similarity score vectors for all the previous frames are circularly shifted based on the difference in their respective dummy orientations with yₜ. The position corresponding to the highest similarity in Sₜ^{A} is the orientation estimate based on the frame sequence in B. At Step 8: Calculate FoV coverage of the frames in Buffer using dummy orientations. Find all the local maxima in the accumulated similarity score Sₜ^{A}. Perform ratio test based on the best and second-best maxima score. At Step 9: If FOV coverage and Lowe's ratio text score are more than δ_{F} and δ_{R} respectively, the estimated orientation measurement qₜ is selected and sent to be used to refine pose estimate. Otherwise, inform the navigation module that the estimated orientation is not reliable. At Step 10: Go to Step 1 to get the next set of frame and pose.

In GPS-challenged instances, both location and orientation estimates are generated. In such instances, it is assumed to have a crude estimate of location and a search region is selected based on location uncertainty (e.g., 100 m×100 m). In the search region, locations are sampled every xₛ meters (e.g., xₛ=2). For all the sampled locations, a reference image database is created collecting a satellite image crop centered at the subject location. Next, the similarity between the camera frame at time t and all the reference images in the database is calculated. After the similarity calculation, the top N (e.g., N=25) possible matches can be selected based on the similarity score to limit the run-time of subsequent estimation steps. Then, these matches can be verified based on whether the matches are consistent over a short frame sequence, f_{d}, (e.g. f_{d}=20). For each of the selected N sample locations, the next probable reference locations can be calculated using the relative pose for the succeeding sequence of frames of length, f_{d}. The above procedure provides an N set of reference image sequences of size f_{d}. In such embodiments, if the similarity score with the camera frames is higher than the selected threshold for all the reference images in a sequence, the corresponding location is considered consistent. In addition, if this approach returns more than one consistent result, the result with the highest combined similarity score can be selected. In such embodiments, a best orientation alignment with the selected reference image sequence can be selected as the estimated orientation for a respective ground image.

The determined orientation and location estimates for a ground image determined in accordance with the present principles can be used to determine refined orientation and location estimates for the ground image. That is, because a located similar reference satellite image determined for the query image, as described above, is geo-tagged, the similar reference satellite image can be used to estimate 3 Degrees of freedom (latitude, longitude and heading) for the query ground image. In the cross-view visual geo-localization system 100 of FIG. 1, the refined orientation and location estimates can then be communicated to the visual-inertial odometry module 110 to update the orientation and location estimates of a ground image (e.g., query).

Embodiments of the present principles, as described above, can be implemented for both providing a cold-start geo-registration estimate at the start of a cross-view visual geo-localization system of the present principles, such as the cross-view visual geo-localization system 100 of FIG. 1, and also for refining orientation and/or location estimates continuously after a cold-start is complete. In the embodiments involving continuous refinement, a smaller search range (i.e., +6 degrees for orientation refinement) around the initial estimate can be considered.

In some embodiments, outlier removal process can be performed based on FoV coverage of the frame sequence and Lowe's ratio test, which compares a best and a second best local maxima in the accumulated similarity score. In such embodiments, a larger value of FoV coverage and ratio test indicates a high confidence prediction. However, in embodiments of continuous refinement, only the ratio test score is used for outlier removal.

As depicted in FIG. 2, in some embodiments an alignment and field-of-view crop process 214 can be implemented by, for example, a cross-view geo-registration module 120 of the present principles. That is, given the geo-location (i.e., Latitude, Longitude) of a camera frame, a portion can be cropped from the satellite image centered at the camera location. As the ground resolution of satellite images varies across areas, it can be ensured the image covers an approximately same-size area as in the training dataset (e.g., the aerial images in CVACT dataset cover approximately 144 m×144 m area). Hence, the size of the aerial image crop depends on the ground resolution for satellite images.

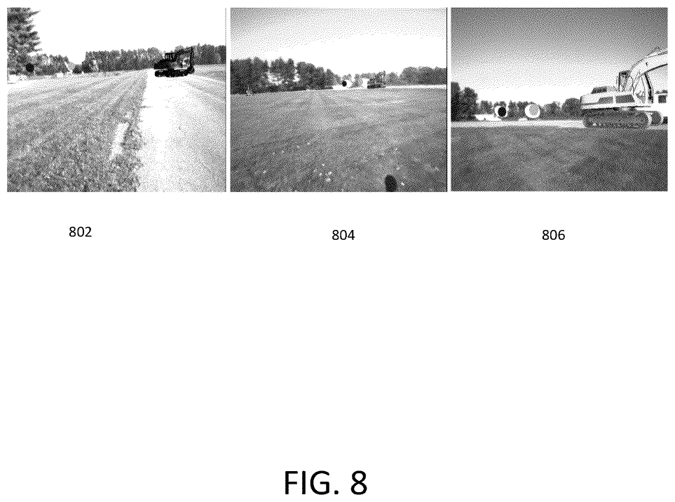

Referring back to FIG. 1, the visual-inertial odometry module 110 of the cross-view visual geo-localization system 100 of FIG. 1 can communicate the estimated orientation and location information, including any refined pose estimates of a ground image, as determined in accordance with the present principles described above, to an optional module for implementing the orientation and location estimates, such as to the optional AR rendering module 150 of FIG. 1. The optional AR rendering module 150 can use the estimated orientation and location information determined by the cross-view geo-registration module 120 and communicated by the visual-inertial odometry module 110 to insert AR objects into the ground image for which the orientation and location information was estimated in an accurate location in the ground image (described in greater detail below with reference to FIG. 8). For example, in some embodiments, a synthetic 3D object can be rendered in a ground image using the estimated ground camera viewpoint and placed/overlaid in the ground camera image via projection into 2D camera image space from a global 3D space. Thus, it is of great importance to have correct estimates of ground camera global location and orientation as any error will manifest in virtual AR insertions being visually inconsistent with augmented camera image.

In an experimental embodiment, a cross-view visual geo-localization system of the present principles, such as the of the cross-view visual geo-localization system 100 of FIG. 1, was tested using two standard benchmark crossview localization datasets (i.e., CVUSA and CVACT). The CVUSA dataset contains 35,532 ground and satellite image pairs that can be used for training and 8,884 image pairs for that can be used for testing. The CVACT dataset provides the same amount of pairs for training and testing. The images in the CVUSA dataset are collected across the USA, whereas the images in the CVACT are collected in Australia. Both datasets provide ground panorama images and corresponding location-paired satellite images. The ground and satellite/aerial images are north-aligned in these datasets. The CVACT dataset also provides the GPS locations along with the ground-satellite image pairs. In the experimental embodiment, both cross-view location and orientation estimation tasks were implemented. That is, for location estimation, results were reported with a rank-based R@k (Recall at k) metric to compare the performance of a cross-view visual geo-localization system of the present principles, such as the of the cross-view visual geo-localization system 100 of FIG. 1, with the state-of-the-art. R@k calculates a percentage of queries for which the ground truth (GT) results are found within the top-k retrievals (higher is better). Specifically, the top-k closest satellite image embeddings to a given ground panorama image embedding are found. If the paired satellite embedding is present with top-k retrieval, then it is considered a success. Results are reported for R@1, R@5, and R@10.

In the experimental embodiment, the orientation of query ground images is predicted using known geo-location of the queries (i.e., the paired satellite/aerial reference image is known). Orientation estimation accuracy is calculated based on the difference between predicted and GT orientation (i.e., orientation error). If the orientation error is within a threshold, j, (i.e., in degrees), the estimated orientation estimation is deemed as correct. For example, in some embodiments of the present principles, a threshold, j, can be set by, for example, a user such that if an orientation error is deemed to be within the threshold, the estimated orientation estimation can be deemed to be correct.

In the experimental embodiment, the machine learning architecture of a cross-view visual geo-localization system of the present principles, such as the cross-view visual geo-localization system 100 of FIG. 1, was implemented in PyTorch. In addition, two NVIDIA GTX 1080Ti GPUs were utilized to train the models. 128×512-sized ground panorama images were used, and the paired satellite images were polar-transformed to the same size. The models were trained using an AdamW optimizer with a cosine learning rate schedule and learning rate of 1e-4. To begin with, a ViT model was pre-trained on the ImageNet dataset and was trained for 100 epochs with a batch size of 16.

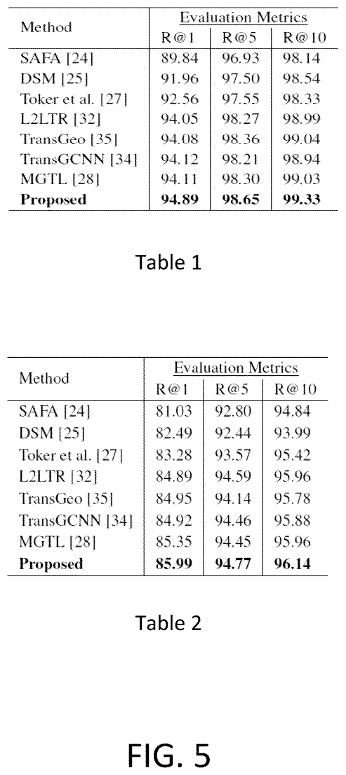

FIG. 5 depicts a first Table (Table 1) including location estimation results of a cross-view visual geo-localization system of the present principles, such as the cross-view visual geo-localization system 100 of FIG. 1, on the CVUSA dataset, and a second Table (Table 2) including location estimation results of a cross-view visual geo-localization system of the present principles, such as the cross-view visual geo-localization system 100 of FIG. 1, on the CVACT dataset. As recited above, in Table1 and Table 2, results are reported for R@1, R@5, and R@10.

In Table1 and Table 2, the location estimation results of the cross-view visual geo-localization system of the present principles are compared with several state-of-the-art cross-view location retrieval approaches including SAFA (spatial aware feature aggregation) presented in Y. Shi, L. Liu, X. Yu, and H. Li; Spatial-aware feature aggregation for cross-view image based geo-localization; Advances in Neural Information Processing Systems, pp. 10090-10100, 2019, DSM (digital surface model) presented in Y. Shi, X. Yu, D. Campbell, and H. Li; Where am i looking at? joint location and orientation estimation by cross-view matching; Proceedings of the IEEE/CVF Conference on Computer Vision and Pattern Recognition, pp. 4064-4072, 2020, Toker et al. presented in A. Toker, Q. Zhou, M. Maximov, and L. Leal-Taix′e. Coming down to earth: Satellite-to-street view synthesis for geo-localization; Proceedings of the IEEE/CVF Conference on Computer Vision and Pattern Recognition, pp. 6488-6497, 2021, L2LTR (layer to layer transformer) presented in H. Yang, X. Lu, and Y. Zhu. Cross-view geo-localization with layer-to-layer transformer; Advances in Neural Information Processing Systems, 34:29009-29020, 2021, TransGeo (transformer geolocalization) presented in S. Zhu, M. Shah, and C. Chen. Transgeo: Transformer is all you need for cross-view image geo-localization; Proceedings of the IEEE/CVF Conference on Computer Vision and Pattern Recognition, pp. 1162-1171, 2022, TransGCNN (transformer-guided convolutional neural network) presented in T. Wang, S. Fan, D. Liu, and C. Sun. Transformer-guided convolutional neural network for cross-view geolocalization; arXiv preprint arXiv:2204.09967, 2022, and MGTL (mutual generative transformer learning) presented in J. Zhao, Q. Zhai, R. Huang, and H. Cheng. Mutual generative transformer learning for cross-view geo-localization; arXiv preprint arXiv:2203.09135, 2022. In Table 1 and Table 2, the best reported results from the respective papers are cited for the compared approaches.

Among the compared approaches, SAFA, DSM, and Toker et al. use CNN-based backbones, whereas the other approaches use Transformer based backbones. It is evident from the results presented in Table 1 and Table 2 that a cross-view visual geo-localization system of the present principles, such as the of the cross-view visual geo-localization system 100 of FIG. 1, performs better than other methods in all the evaluation metrics. It is also evident from the results presented in Table 1 and Table 2 that the transformer-based approaches achieve large performance improvement over CNN-based approaches. For example, the best CNN-based method (i.e., Toker et al.) achieves R@1 of 92.56 in CVUSA and 83.28 in CVACT, whereas the best Transformer-based approach (i.e., the cross-view visual geo-localization system of the present principles) achieves significantly higher R@1 of 94.89 in CVUSA and 85.99 in CVACT. That is, among the Transformer-based approaches, the cross-view visual geo-localization system of the present principles provides the best results. That is, the joint location and orientation estimation capability of the present principles better handles the cross-view domain gap, when compared with the other state of the art approaches.

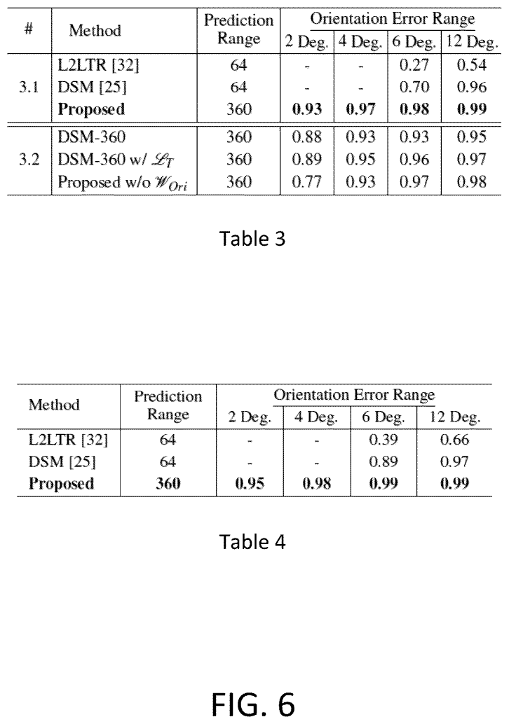

For example, FIG. 6 depicts a third Table (Table 3) including orientation estimation results of a cross-view visual geo-localization system of the present principles, such as the cross-view visual geo-localization system 100 of FIG. 1, on the CVUSA dataset, and a fourth Table (Table 4) including orientation estimation results of a cross-view visual geo-localization system of the present principles, such as the cross-view visual geo-localization system 100 of FIG. 1, on the CVACT dataset. In Table 3 and Table 4, the orientation estimation results of the cross-view visual geo-localization system of the present principles are compared with several state-of-the-art orientation estimation approaches including the previously described CNN-based DSM approach and the previously described ViT-based L2LTR model. As there are no prior Transformer-based models trained for orientation estimation as implemented by the cross-view visual geo-localization system of the present principles, the L2LTR baseline is presented in Table 3 and Table 4 to demonstrate how Transformer-based models trained on location estimation work on orientation estimation. From the results presented in Table 3 and Table 4, it is evident that the cross-view visual geo-localization system of the present principles shows huge improvements not only in orientation estimation accuracy but also in the granularity of prediction.

Because the DSM network architecture only trains to estimate orientation at a granularity of 5.6 degrees compared to 1 degree in a cross-view visual geo-localization system of the present principles, a fair comparison is not directly possible. As such, the DSM model was extended by removing some pooling layers in the CNN model and changing the input size so that orientation estimation at 1 degree granularity was possible. In Table 3, the extended DSM model is identified as “DSM-360”. The second baseline in row 3.2 is “DSM-360 w/LT” which trains DSM-360 with the proposed loss. Comparing the performance of DSM-360 and DSM-360 w/LT with a cross-view visual geo-localization system of the present principles in Table 3 and Table 4, it is evident that the Transformer-based model of the present principles shows significant performance improvement across orientation estimation metrics.

For example, the cross-view visual geo-localization system of the present principles achieves orientation error with 2 Degrees (Deg.) for 93% of ground image queries, whereas DSM-360 achieves 88%. We also observe that DSM-360 trained with the proposed LT loss achieves consistent performance improvement over DSM-360. However, the performance is still significantly lower than the performance of the cross-view visual geo-localization system of the present principles. The third baseline in row 3.2 of Table 3 is labeled “Proposed w/o WOri”. This baseline follows the network architecture of a cross-view visual geo-localization system of the present principles, but it is trained with standard soft-margin triplet loss LGS (i.e., without any orientation estimation based weighting WOri). In section 3.2 of Table 3, it can be observed that, for higher orientation error ranges (e.g., 6 deg., 12 deg.), comparable results to the cross-view visual geo-localization system of the present principles having orientation estimation based weighting WOri are achieved. However, for finer orientation error ranges (e.g., 2 deg.), there is an evident drastic drop in performance. From these results, it is evident that the proposed weighted loss function of the present principles is crucial for a model of the present principles to learn to handle ambiguities in fine-grained geo-orientation estimation.

As mentioned earlier, to create a smooth AR experience for the user, the augmented objects need to be placed at the desired position continuously and not drift over time. This can only be achieved by using accurate and consistent geo-registration in real-time as provided by a cross-view visual geo-localization system of the present principles, such as the cross-view visual geo-localization system 100 of FIG. 1. In an experimental embodiment, a cross-view visual geo-localization system of the present principles was implemented and executed on an MSI VR backpack computer (with Intel Core i7 CPU, 16 GB of RAM, and Nvidia GTX 1070 GPU). The AR renderer of the experimental cross-view visual geo-localization system included a Unity3D based real-time renderer, which can also handle occlusions by real objects when depth maps are provided. The sensor package of the experimental cross-view visual geo-localization system included an Intel Realsense D435i device and a GPS device. The Intel Realsense was the primary sensor and included a stereo camera, RGB camera, and an IMU. The computation of EKF-based visual-inertial odometry of the experimental cross-view visual geo-localization system took about 30 msecs on average for each video frame. The crossview geo-registration process (with neural network feature extraction and reference image processing) of the experimental cross-view visual geo-localization system took an average of 200 msecs to process an input (query) image. In the geo-registration module of the experimental cross-view visual geo-localization system, the neural network model trained on the CVUSA dataset.

In the experimental embodiment, 3 sets of navigation sequences were collected by walking around in different places across United States. The ground image data was captured at 15 Hz. For the test sequences, differential GPS and magnetometer devices were used as additional sensors to create ground-truth poses for evaluation. It should be noted that the additional sensor data was not used in the outdoor AR system to generate results. The ground camera (a color camera from Intel Realsense D435i) RGB images had a 69 degree horizontal FoV. For all of the datasets, corresponding georeferenced satellite imagery for the region collected from USGS EarthExplorer was available. Digital Elevation Model data from USGS was also collected and used to estimate the height.

The first set of navigation sequences was collected in a semi-urban location in Mercer County, New Jersey. The first set comprised three sequences with a total duration of 32 minutes and a trajectory/path length of 2.6 km. The three sequences covered both urban and suburban areas. The collection areas had some similarities to the benchmark datasets (e.g., CVUSA) in terms of the number of distinct structures and a combination of buildings and vegetation.

The second set of navigation sequences was collected in Prince William County, Virginia. The second set comprised of two sequences with a total duration of 24 minutes and a trajectory length of 1.9 km. One of the sequences of the second set was collected in an urban area and the other was collected in a golf course green field. The sequence collected while walking on a green field was especially challenging as there were minimal man-made structures (e.g., buildings, roads) in the scene.

The third set of navigation sequences was collected in Johnson County, Indiana. The third set comprised two sequences with a total duration of 14 minutes and a trajectory length of 1.1 km. These sequences were collected in a rural community with few man-made structures.

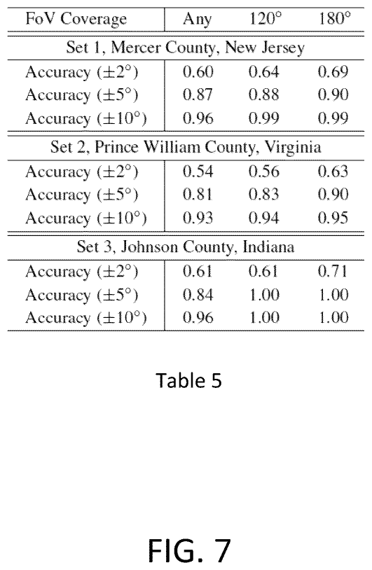

A full 360 degree heading estimation was performed on the navigation sequences described above. FIG. 7, depicts a Table (Table 5) of the results of the application of a cross-view visual geo-localization system of the present principles, such as the cross-view visual geo-localization system 100 of FIG. 1, to the image data from the navigation sequences described above. In the experimental embodiment, predictions were accumulated over a sequence of frames for 10 seconds based on the estimation algorithm depicted in FIG. 4.

In Table 5 of FIG. 7, accuracy values are reported when the differences between the predicted heading and its ground-truth heading are within +/−2°, +/−5°, and +/−10°. In Table 5, accuracy values are also reported with respect to different FoV coverage. From Table 5 of FIG. 7, it can be noted that orientation estimation performance using a cross-view visual geo-localization system of the present principles, such as the cross-view visual geo-localization system 100 of FIG. 1, is consistent across datasets. From Table 5 of FIG. 7, it is observed that the accuracy in Set 2 is slightly lower because part of the set was collected in an open green field, which is significantly different from the training set and the view has limited context nearby for matching. In Table 5 of FIG. 7, it is observed that the best performance is in Set 3 even though Set 3 was collected in a rural area. The result is most likely attributable to the fact that Set 3 was mostly recorded by walking along streets. That is, Set 3 was collected as a user was looking around which provides an NN model and matching algorithm of the present principles to generate high confidence estimates. From the results of Table 5 of FIG. 7, it is notable that with an increase in FoV coverage, the heading estimation accuracy increases as expected.

In accordance with the present principles, the estimation information for the first set of navigation sequences can be communicated to an AR renderer of the present principles, such as the AR rendering module 150 of the cross-view visual geo-localization system 100 of FIG. 1. The AR renderer of the present principles can use the determined estimation information to locate an AR image in a ground image associated with the navigation sequences of Set 1. For example, FIG. 8 depicts three screenshots 802, 804, and 806 of a semi-urban scene of the first set of navigation sequences. The three screenshots 802, 804, and 806 of FIG. 8 each illustratively include two satellite dishes marked with a lighter circle and a darker circle acting as reference points (e.g., anchor points). As depicted in FIG. 8, using the determined estimation information, the AR renderer of the present principles inserts a synthetic (AR) excavator in each of the three screenshots 802, 804, and 806.

Each of the screenshots/frames 802, 804, and 806 in FIG. 8 are taken from different perspectives, however as depicted in FIG. 8, the anchor points and inserted objects appear at the correct spot.

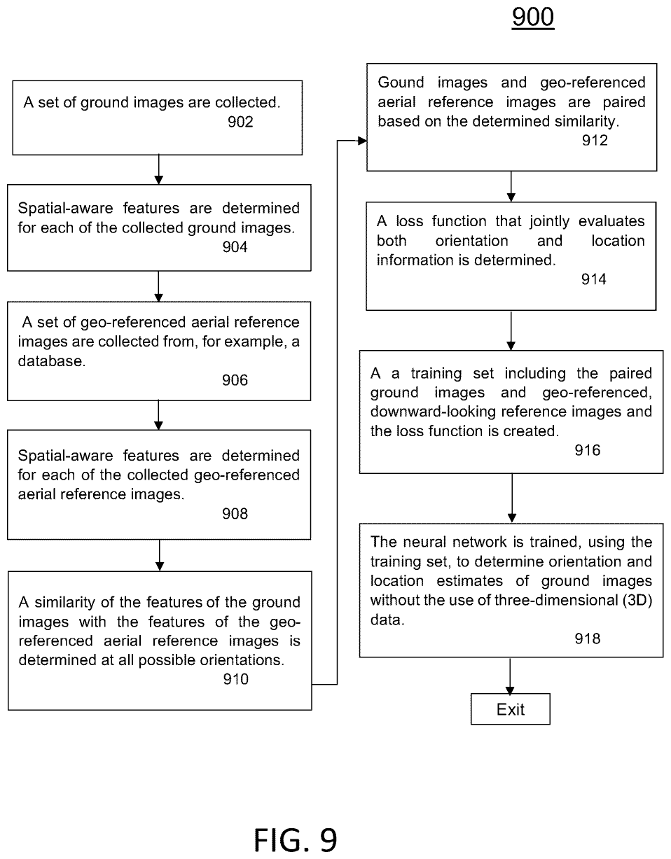

FIG. 9 depicts a flow diagram of a computer-implemented method 900 of training a neural network for orientation and location estimation of ground images in accordance with an embodiment of the present principles. The method 900 can begin at 902 during which a set of ground images are collected. The method 900 can proceed to 904.

At 904, spatial-aware features are determined for each of the collected ground images. The method 900 can proceed to 906.

At 906, a set of geo-referenced, downward-looking reference images are collected from, for example, a database. The method 900 can proceed to 908.

At 908, spatial-aware features are determined for each of the collected geo-referenced, downward-looking reference images. The method 900 can proceed to 910.

At 910, a similarity of the spatial-aware features of the ground images with the spatial-aware features of the geo-referenced, downward-looking reference images is determined. The method 900 can proceed to 912.

At 912, ground images and geo-referenced, downward-looking reference images are paired based on the determined similarity. The method 900 can proceed to 914.

At 914, a loss function that jointly evaluates both orientation and location information is determined. The method 900 can proceed to 916.

At 916, a training set including the paired ground images and geo-referenced, downward-looking reference images and the loss function is created. The method 900 can proceed to 918.

At 918, the neural network is trained, using the training set, to determine orientation and location estimates of ground images without the use of three-dimensional (3D) data. The method 900 can then be exited.

In some embodiments of the method, the spatial-aware features for the ground images and the spatial-aware features for the geo-referenced, downward-looking reference images are determined using at least one neural network including a vision transformer.

In some embodiments, the method can further include applying a polar transformation to at least one of the geo-referenced, downward-looking reference images prior to determining the spatial-aware features for the geo-referenced, downward-looking reference images.

In some embodiments, the method can further include applying an orientation-weighted triplet ranking loss function to train the neural network.

In some embodiments, in the method training the neural network can include determining a vector representation of the features of the matching image pairs of the ground images and the geo-referenced, downward-looking reference images and jointly embedding the feature vector representation of each of the matching image pairs in a common embedding space such that the feature embeddings of matching image pairs of the ground images and the geo-referenced, downward-looking reference images are closer together in the embedding space while the feature embeddings of not matching pairs are further apart.

In some embodiments, a computer-implemented method of training a neural network for providing orientation and location estimates for ground images includes collecting a set of two-dimensional (2D) ground images, determining spatial-aware features for each of the collected 2D ground images, collecting a set of 2D geo-referenced, downward-looking reference images, determining spatial-aware features for each of the collected 2D geo-referenced, downward-looking reference images, determining a similarity of the spatial-aware features of the 2D ground images with the spatial-aware features of the 2D geo-referenced, downward-looking reference images, pairing 2D ground images and 2D geo-referenced, downward-looking reference images based on the determined similarity, determining a loss function that jointly evaluates both orientation and location information, creating a training set including the paired 2D ground images and 2D geo-referenced, downward-looking reference images and the loss function, and training, using the training set, the neural network to determine orientation and location estimates of ground images without the use of three-dimensional (3D) data.

In some embodiments of the method, the spatial-aware features for the 2D ground images and the spatial-aware features for the 2D geo-referenced, downward-looking reference images are determined using at least one neural network including a vision transformer.

In some embodiments, the method can further include applying a polar transformation to at least one of the 2D geo-referenced, downward-looking reference images prior to determining the spatial-aware features for the 2D geo-referenced, downward-looking reference images.

In some embodiments, the method can further include applying an orientation-weighted triplet ranking loss function to train the neural network.

In some embodiments, in the method training the neural network can include determining a vector representation of the features of the matching image pairs of the 2D ground images and the 2D geo-referenced, downward-looking reference images and jointly embedding the feature vector representation of each of the matching image pairs in a common embedding space such that the feature embeddings of matching image pairs of the ground images and the geo-referenced, downward-looking reference images are closer together in the embedding space while the feature embeddings of not matching pairs are further apart.

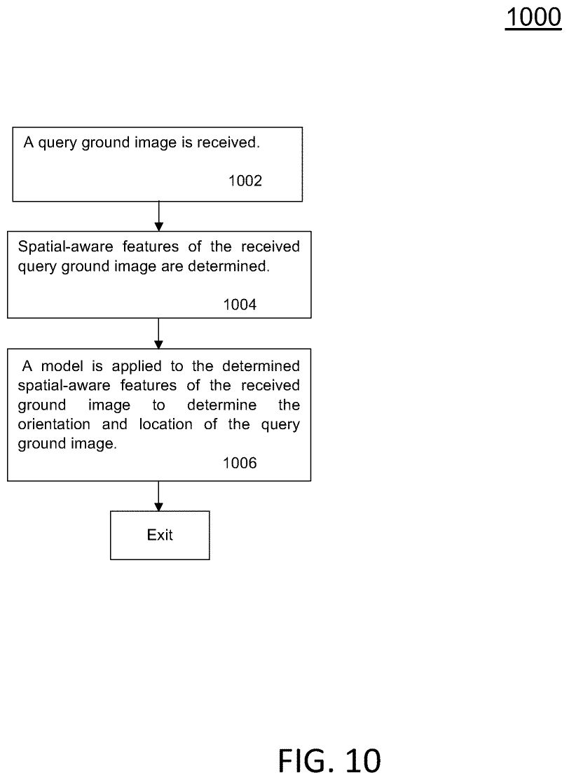

FIG. 10 depicts a flow diagram of a method for estimating an orientation and location of a ground image in accordance with an embodiment of the present principles. The method 1000 can begin at 1002 during which a ground image (query) is received. The method 1000 can proceed to 1004.

At 1004, spatial-aware features of the received query ground image are determined. The method 1000 can proceed to 1006.

At 1006, a model is applied to the determined spatial-aware features of the received ground image to determine the orientation and location of the ground image. The method 1000 can be exited.

In some embodiments of the present principles, in the method 1000, applying a model to the determined features of the received ground image can include determining at least one vector representation of the determined features of the received ground image, and projecting the at least one vector representation into a trained embedding space to determine the orientation and location of the ground image. In some embodiments and as described above, the trained embedding space can be trained by collecting a set of ground images, determining spatial-aware features for each of the collected ground images, collecting a set of geo-referenced, downward-looking reference images, determining spatial-aware features for each of the collected geo-referenced, downward-looking reference images, determining a similarity of the spatial-aware features of the ground images with the spatial-aware features of the geo-referenced, downward-looking reference images, pairing ground images and geo-referenced, downward-looking reference images based on the determined similarity, determining a loss function that jointly evaluates both orientation and location information, creating a training set including the paired ground images and geo-referenced, downward-looking reference images and the loss function, and training the neural network to determine orientation and location estimation of ground images using the training set.

As such and in accordance with the present principles and as previously described above, when a ground image (query) is received, the features of the ground image can be projected into the trained embedding space. As such, a previously embedded ground image that contains features most like the received ground image (query) can be identified in the embedding space. From the identified ground image embedded in the embedding space, a paired geo-referenced aerial reference image in the embedding space that is closest to the embedded ground image can be identified. Orientation and location information in the identified geo-referenced aerial reference image can be used along with any orientation and location information collected with the received ground image (query) to determine a most accurate orientation and location information for the ground image (query) in accordance with the present principles.

In some embodiments, in the method 1000 an orientation of the query ground image is determined by aligning spatial-aware features of the query image with spatial-aware features of the matching geo-referenced, downward-looking reference image.

In some embodiments, in the method 1000 the spatial-aware features for the query ground image are determined using at least one neural network including a vision transformer.

In some embodiments, in the method 1000 the determined orientation and location for the query ground image is used to update at least one of an orientation or a location of the query ground image.

In some embodiments, in the method 1000 at least one of the determined orientation and location for the query ground image and/or the updated orientation and location for the query ground image of the query ground image is used to insert an augmented reality object into the query ground image and/or to provide navigation information to a real-time navigation system.

In some embodiments, a method for providing orientation and location estimates for a query ground image includes determining spatial-aware features of a received query ground image, and applying a model to the determined spatial-aware features of the received query ground image to determine the orientation and location of the query ground image. In some embodiments, the model can be trained by collecting a set of two-dimensional (2D) ground images, determining spatial-aware features for each of the collected 2D ground images, collecting a set of 2D geo-referenced, downward-looking reference images, determining spatial-aware features for each of the collected 2D geo-referenced, downward-looking reference images, determining a similarity of the spatial-aware features of the 2D ground images with the spatial-aware features of the 2D geo-referenced, downward-looking reference images, pairing 2D ground images and 2D geo-referenced, downward-looking reference images based on the determined similarity, determining a loss function that jointly evaluates both orientation and location information, creating a training set including the paired 2D ground images and 2D geo-referenced, downward-looking reference images and the loss function, and training, using the training set, the neural network to determine orientation and location estimates of ground images without the use of three-dimensional (3D) data.

In some embodiments, an apparatus for estimating an orientation and location of a query ground image includes a processor and a memory accessible to the processor, the memory having stored therein at least one of programs or instructions. In some embodiments, when the programs or instructions are executed by the processor, the apparatus is configured to determine spatial-aware features of a received query ground image, and apply a machine learning model to the determined features of the received query ground image to determine the orientation and location of the query ground image. In some embodiments, the model can be trained by collecting a set of ground images, determining spatial-aware features for each of the collected ground images, collecting a set of geo-referenced, downward-looking reference images, determining spatial-aware features for each of the collected geo-referenced, downward-looking reference images, determining a similarity of the spatial-aware features of the ground images with the spatial-aware features of the geo-referenced, downward-looking reference images, pairing ground images and geo-referenced, downward-looking reference images based on the determined similarity, determining a loss function that jointly evaluates both orientation and location information, creating a training set including the paired ground images and geo-referenced, downward-looking reference images and the loss function, and training, using the training set, the neural network to determine orientation and location estimates of ground images without the use of three-dimensional (3D) data.

In some embodiments, a system for providing orientation and location estimates for a query ground image includes a neural network module including a model trained for providing orientation and location estimates for ground images, a cross-view geo-registration module configured to process determined spatial-aware image features, an image capture device, a database configured to store geo-referenced, downward-looking reference images, and an apparatus including a processor and a memory accessible to the processor, the memory having stored therein at least one of programs or instructions. In some embodiments, when the programs or instructions are executed by the processor, the apparatus is configured to determine spatial-aware features of a received query ground image, captured by the capture device, using the neural network module, and apply the model to the determined spatial-aware features of the received query ground image to determine the orientation and location of the query ground image. In some embodiments, the model can be trained by collecting a set of ground images, determining spatial-aware features for each of the collected ground images, collecting a set of geo-referenced, downward-looking reference images, determining spatial-aware features for each of the collected geo-referenced, downward-looking reference images, determining a similarity of the spatial-aware features of the ground images with the spatial-aware features of the geo-referenced, downward-looking reference images, pairing ground images and geo-referenced, downward-looking reference images based on the determined similarity, determining a loss function that jointly evaluates both orientation and location information, creating a training set including the paired ground images and geo-referenced, downward-looking reference images and the loss function, and training, using the training set, the neural network to determine orientation and location estimates of ground images without the use of three-dimensional (3D) data.

As depicted in FIG. 1, embodiments of a cross-view visual geo-localization system 100 of the present principles, such as the cross-view visual geo-localization system 100 of FIG. 1, can be implemented in a computing device 1100 in accordance with the present principles. That is, in some embodiments, ground images/videos can be communicated to, for example, the visual-inertial odometry module 110 of the cross-view visual geo-localization system using the computing device 1100 via, for example, any input/output means associated with the computing device 1100. Data associated with a cross-view visual geo-localization system in accordance with the present principles can be presented to a user using an output device of the computing device 1100, such as a display, a printer or any other form of output device.

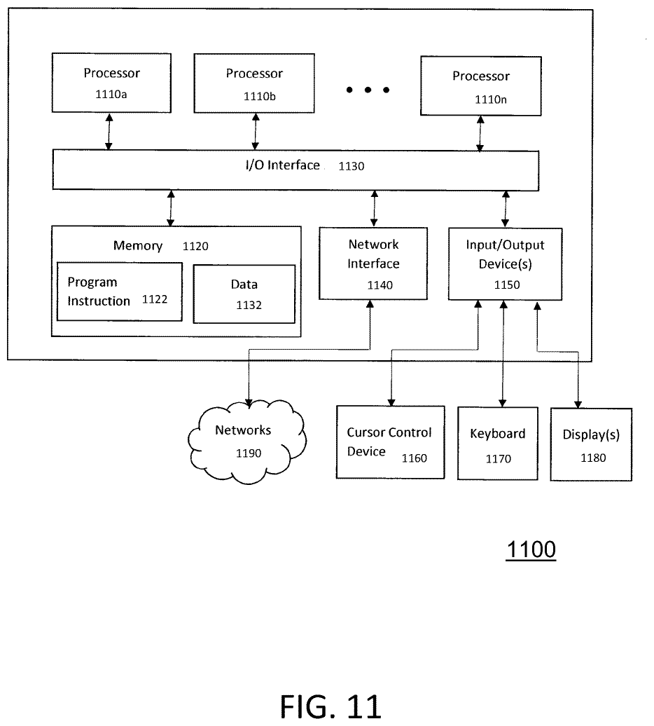

For example, FIG. 11 depicts a high-level block diagram of a computing device 1100 suitable for use with embodiments of a cross-view visual geo-localization system in accordance with the present principles such as the cross-view visual geo-localization system 100 of FIG. 1. In some embodiments, the computing device 1100 can be configured to implement methods of the present principles as processor-executable program instructions 1122 (e.g., program instructions executable by processor(s) 1110) in various embodiments.

In the embodiment of FIG. 11, the computing device 1100 includes one or more processors 1110a-1110n coupled to a system memory 1120 via an input/output (I/O) interface 1130. The computing device 1100 further includes a network interface 1140 coupled to I/O interface 1130, and one or more input/output devices 1150, such as cursor control device 1160, keyboard 1170, and display(s) 1180. In various embodiments, a user interface can be generated and displayed on display 1180. In some cases, it is contemplated that embodiments can be implemented using a single instance of computing device 1100, while in other embodiments multiple such systems, or multiple nodes making up the computing device 1100, can be configured to host different portions or instances of various embodiments. For example, in one embodiment some elements can be implemented via one or more nodes of the computing device 1100 that are distinct from those nodes implementing other elements. In another example, multiple nodes may implement the computing device 1100 in a distributed manner.

In different embodiments, the computing device 1100 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 1100 can be a uniprocessor system including one processor 1110, or a multiprocessor system including several processors 1110 (e.g., two, four, eight, or another suitable number). Processors 1110 can be any suitable processor capable of executing instructions. For example, in various embodiments processors 1110 may be general-purpose or embedded processors implementing any of a variety of instruction set architectures (ISAs). In multiprocessor systems, each of processors 1110 may commonly, but not necessarily, implement the same ISA.

System memory 1120 can be configured to store program instructions 1122 and/or data 1132 accessible by processor 1110. In various embodiments, system memory 1120 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 1120. In other embodiments, program instructions and/or data can be received, sent or stored upon different types of computer-accessible media or on similar media separate from system memory 1120 or computing device 1100.

In one embodiment, I/O interface 1130 can be configured to coordinate I/O traffic between processor 1111, system memory 1120, and any peripheral devices in the device, including network interface 1140 or other peripheral interfaces, such as input/output devices 1150. In some embodiments, I/O interface 1130 can perform any necessary protocol, timing or other data transformations to convert data signals from one component (e.g., system memory 1120) into a format suitable for use by another component (e.g., processor 1110). In some embodiments, I/O interface 1130 can include support for devices attached through various types of peripheral buses, such as a variant of the Peripheral Component Interconnect (PCI) bus standard or the Universal Serial Bus (USB) standard, for example. In some embodiments, the function of I/O interface 1130 can be split into two or more separate components, such as a north bridge and a south bridge, for example. Also, in some embodiments some or all of the functionality of I/O interface 1130, such as an interface to system memory 1120, can be incorporated directly into processor 1110.

Network interface 1140 can be configured to allow data to be exchanged between the computing device 1100 and other devices attached to a network (e.g., network 1190), such as one or more external systems or between nodes of the computing device 1100. In various embodiments, network 1190 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1140 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 1150 can, in some embodiments, include one or more display terminals, keyboards, keypads, touchpads, scanning devices, voice or optical recognition devices, or any other devices suitable for entering or accessing data by one or more computer systems. Multiple input/output devices 1150 can be present in computer system or can be distributed on various nodes of the computing device 1100. In some embodiments, similar input/output devices can be separate from the computing device 1100 and can interact with one or more nodes of the computing device 1100 through a wired or wireless connection, such as over network interface 1140.

Those skilled in the art will appreciate that the computing device 1100 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 1100 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 1100 can communicate with other computing devices based on various computer communication protocols such a Wi-Fi, Bluetooth.® (and/or other standards for exchanging data over short distances includes protocols using short-wavelength radio transmissions), USB, Ethernet, cellular, an ultrasonic local area communication protocol, etc. The computing device 1100 can further include a web browser.

Although the computing device 1100 is depicted as a general-purpose computer, the computing device 1100 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

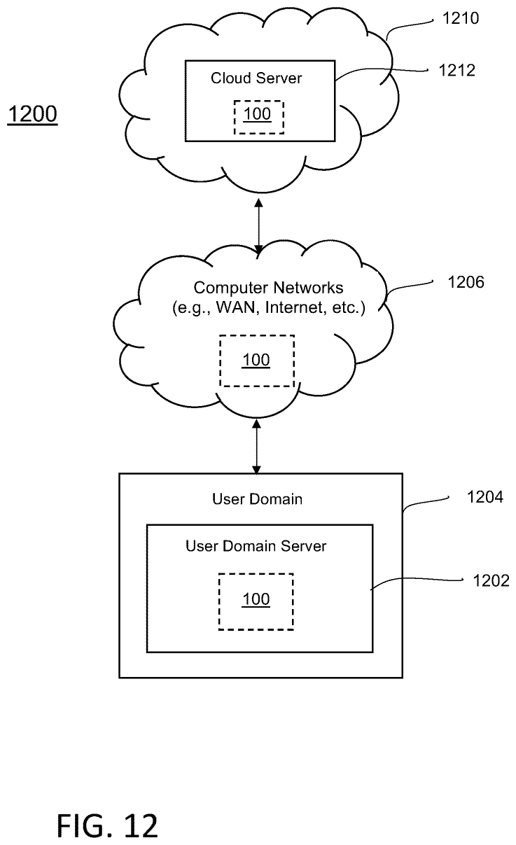

FIG. 12 depicts a high-level block diagram of a network in which embodiments of a cross-view visual geo-localization system in accordance with the present principles, such as the cross-view visual geo-localization system 100 of FIG. 1, can be applied. The network environment 1200 of FIG. 12 illustratively comprises a user domain 1202 including a user domain server/computing device 1204. The network environment 1200 of FIG. 12 further comprises computer networks 1206, and a cloud environment 1210 including a cloud server/computing device 1212.

In the network environment 1200 of FIG. 12, a system for cross-view visual geo-localization in accordance with the present principles, such as the cross-view visual geo-localization system 100 of FIG. 1, can be included in at least one of the user domain server/computing device 1204, the computer networks 1206, and the cloud server/computing device 1212. That is, in some embodiments, a user can use a local server/computing device (e.g., the user domain server/computing device 1204) to provide orientation and location estimates in accordance with the present principles.

In some embodiments, a user can implement a system for cross-view visual geo-localization in the computer networks 1206 to provide orientation and location estimates in accordance with the present principles. Alternatively or in addition, in some embodiments, a user can implement a system for cross-view visual geo-localization in the cloud server/computing device 1212 of the cloud environment 1210 in accordance with the present principles. For example, in some embodiments it can be advantageous to perform processing functions of the present principles in the cloud environment 1210 to take advantage of the processing capabilities and storage capabilities of the cloud environment 1210. In some embodiments in accordance with the present principles, a system for providing cross-view visual geo-localization can be located in a single and/or multiple locations/servers/computers to perform all or portions of the herein described functionalities of a system in accordance with the present principles. For example, in some embodiments components of a cross-view visual geo-localization system of the present principles, such as the visual-inertial-odometry module 110, the cross-view geo-registration module 120, the reference image pre-processing module 130, the neural network feature extraction module 140, and the optional augmented reality (AR) rendering module 150 can be located in one or more than one of the user domain 1202, the computer network environment 1206, and the cloud environment 1210 for providing the functions described above either locally and/or remotely and/or in a distributed manner.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 1100 can be transmitted to the computing device 1100 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A computer-implemented method of training a neural network for providing orientation and location estimates for ground images, comprising:
collecting a set of ground images;
determining spatial-aware features for each of the collected ground images;
collecting a set of geo-referenced, downward-looking reference images;
determining spatial-aware features for each of the collected geo-referenced, downward-looking reference images;
determining a similarity of the spatial-aware features of the ground images with the spatial-aware features of the geo-referenced, downward-looking reference images;
pairing ground images and geo-referenced, downward-looking reference images based on the determined similarity;
determining a loss function that jointly evaluates both orientation and location information;
creating a training set including the paired ground images and geo-referenced, downward-looking reference images and the loss function; and
training, using the training set, the neural network to determine orientation and location estimates of ground images without the use of three-dimensional (3D) data.

2. The method of claim 1, wherein the spatial-aware features for the ground images and the spatial-aware features for the geo-referenced, downward-looking reference images are determined using at least one neural network including a vision transformer.

3. The method of claim 1, further comprising applying a polar transformation to at least one of the geo-referenced, downward-looking reference images prior to determining the spatial-aware features for the geo-referenced, downward-looking reference images.

4. The method of claim 1, further comprising applying an orientation-weighted triplet ranking loss function to train the neural network.

5. The method of claim 1, wherein training the neural network comprises:
determining a vector representation of the features of the matching image pairs of the ground images and the geo-referenced, downward-looking reference images; and
jointly embedding the feature vector representation of each of the matching image pairs in a common embedding space such that the feature embeddings of matching image pairs of the ground images and the geo-referenced, downward-looking reference images are closer together in the embedding space while the feature embeddings of not matching pairs are further apart.

6. A method for providing orientation and location estimates for a query ground image, comprising:
receiving a query ground image;
determining spatial-aware features of the received query ground image; and
applying a model to the determined spatial-aware features of the received query ground image to determine the orientation and location of the query ground image, the model having been trained by:
collecting a set of ground images;
determining spatial-aware features for each of the collected ground images;
collecting a set of geo-referenced, downward-looking reference images;
determining spatial-aware features for each of the collected geo-referenced, downward-looking reference images;
determining a similarity of the spatial-aware features of the ground images with the spatial-aware features of the geo-referenced, downward-looking reference images;
pairing ground images and geo-referenced, downward-looking reference images based on the determined similarity;
determining a loss function that jointly evaluates both orientation and location information;
creating a training set including the paired ground images and geo-referenced, downward-looking reference images and the loss function; and
training, using the training set, the neural network to determine orientation and location estimates of ground images without the use of three-dimensional (3D) data.

7. The method of claim 6, wherein applying a machine learning model to the determined spatial-aware features of the received ground image to determine the orientation and location of the ground image comprises:
projecting the spatial-aware features of the query ground image into an embedding space having been trained by embedding features of matching image pairs of the ground images and the geo-referenced, downward-looking reference image to identify a geo-referenced, downward-looking reference image having features matching the projected features of the query ground image; and
determining the orientation and location of the query ground image using at least one of information contained in the embedded, matching geo-referenced, downward-looking reference image and/or information captured with the query ground image.

8. The method of claim 7, wherein an orientation of the query ground image is determined by aligning spatial-aware features of the query image with spatial-aware features of the matching geo-referenced, downward-looking reference image.

9. The method of claim 6, wherein the spatial-aware features for the query ground image are determined using at least one neural network including a vision transformer.

10. The method of claim 6, wherein the determined orientation and location for the query ground image is used to update at least one of an orientation or a location of the query ground image.

11. The method of claim 10, wherein at least one of the determined orientation and location for the query ground image and/or the updated orientation and location for the query ground image of the query ground image is used to insert an augmented reality object into the query ground image and/or to provide navigation information to a real-time navigation system.

12. An apparatus for estimating an orientation and location of a query ground image, comprising:
a processor; and
a memory accessible to the processor, the memory having stored therein at least one of programs or instructions executable by the processor to configure the apparatus to:
determine spatial-aware features of a received query ground image; and
apply a machine learning model to the determined features of the received query ground image to determine the orientation and location of the query ground image, the machine learning model having been trained by:
collecting a set of ground images;
determining spatial-aware features for each of the collected ground images;
collecting a set of geo-referenced, downward-looking reference images;
determining spatial-aware features for each of the collected geo-referenced, downward-looking reference images;
determining a similarity of the spatial-aware features of the ground images with the spatial-aware features of the geo-referenced, downward-looking reference images;
pairing ground images and geo-referenced, downward-looking reference images based on the determined similarity;
determining a loss function that jointly evaluates both orientation and location information;
creating a training set including the paired ground images and geo-referenced, downward-looking reference images and the loss function; and
training, using the training set, the neural network to determine orientation and location estimates of ground images without the use of three-dimensional (3D) data.

13. The apparatus of claim 12, wherein for applying a machine learning model to the determined features of the received query ground image to determine the orientation and location of the query ground image, the apparatus is configured to:
project the features of the query ground image into an embedding space having been trained by embedding features of matching image pairs of the ground images and the geo-referenced, downward-looking reference images to identify a geo-referenced, downward-looking reference image having features matching the projected features of the query ground image; and
determine the orientation and location of the query ground image using at least one of information contained in the embedded, matching geo-referenced, downward-looking reference image and/or information captured with the query ground image.

14. The apparatus of claim 12, wherein the features for the query ground image are determined using at least one neural network including a vision transformer.

15. The apparatus of claim 12, wherein the model is further trained by applying an orientation-weighted triplet ranking loss function.

16. The apparatus of claim 12, wherein the determined orientation and location for the query ground image is used to update at least one of an orientation or a location of the query ground image.

17. The apparatus of claim 16, wherein at least one of the determined orientation and location for the query ground image and/or the updated orientation and location of the query ground image is used to insert an augmented reality object into the query ground image and/or to provide navigation information to a real-time navigation system.

18. A system for providing orientation and location estimates for a query ground image, comprising:
a neural network module including a model trained for providing orientation and location estimates for ground images;
a cross-view geo-registration module configured to process determined spatial-aware image features;
an image capture device;
a database configured to store geo-referenced, downward-looking reference images; and
an apparatus comprising a processor and a memory accessible to the processor, the memory having stored therein at least one of programs or instructions executable by the processor to configure the apparatus to:
determine spatial-aware features of a received query ground image, captured by the capture device, using the neural network module; and
apply the model to the determined spatial-aware features of the received query ground image to determine the orientation and location of the query ground image, the model having been trained by:
collecting a set of ground images using the image capture device;
determining spatial-aware features for each of the collected ground images using the neural network module;
collecting a set of geo-referenced, downward-looking reference images from the database;
determining spatial-aware features for each of the collected geo-referenced, downward-looking reference images using the neural network module;
determining a similarity of the spatial-aware features of the ground images with the spatial-aware features of the geo-referenced, downward-looking reference images using the cross-view geo-registration module;
pairing ground images and geo-referenced, downward-looking reference images based on the determined similarity using the cross-view geo-registration module;
determining a loss function that jointly evaluates both orientation and location information using the cross-view geo-registration module;
creating a training set including the paired ground images and geo-referenced, downward-looking reference images and the loss function using the cross-view geo-registration module; and
training, using the training set, the neural network to determine orientation and location estimates of ground images without the use of three-dimensional (3D) data.

19. The system of claim 18, further comprising a pre-processing module and wherein the apparatus is further configured to:
apply a polar transformation to at least one of the geo-referenced, downward-looking reference images prior to determining the spatial-aware features for the geo-referenced, downward-looking reference images.

20. The system of claim 18, further comprising at least one of an augmented reality rendering module or a real-time navigation module and wherein the apparatus is further configured to:
update at least one of an orientation or a location of the query ground image using the determined orientation and location for the query ground image; and
use the augmented reality rendering module or the real-time navigation module to insert an augmented reality object into the query ground image and/or to provide navigation information to a real-time navigation system using at least one of the determined orientation and location for the query ground image and/or the updated orientation and location for the query ground image.
